(19) United States
(12) Patent Application Publication
(10) Pub. No.: US 2004/0023195 A1
(43) Pub. Date: Feb. 5, 2004

(54) Method for learning language through a role-playing game

(76) Inventors: Say Ling Wen, Taipei (TW); Zechary Chang, Taipei (TW); Pinky Ma, Beijing (CN)

Correspondence Address: JACOBSON HOLMAN PLLC, 400 SEVENTH STREET N.W., SUITE 600, WASHINGTON, DC, 20004, US

(21) Appl. No.: 10/211,527

(22) Filed: Aug. 5, 2002

(51) Int. Cl. G09B 19/04

(52) U.S. Cl. 434/185; 434/169; 434/307 R; 434/118

(57) ABSTRACT

A system and method for learning language through a role-playing game. The role-playing game integrates the learning process of making sentences. The game includes role and situation simulations, interactive learning and versatile scene and events. Therefore, the learner feels interested, pays attention to learning and fully utilizes his or her imagination and memorization so that learning can be efficiently achieved.

### BACKGROUND OF THE INVENTION

1. Field of the Invention

The invention generally relates to a computer-assisted system and method for learning a language, and more particularly relates to a system and method for learning language through a role-playing game that provides interactive and versatile activities.

2. Related Art

The objective of learning a language is to achieve fluency in listening, speaking, reading and writing of the language. For practicing a language, the learner has to be familiar with sentences, which are the basics of a language. Only when the construction, sequence and modes of words are correctly used can sentences be made, and the ability of using the language achieved.

It always takes a long time and is hard work to learn a language. The process of learning is mostly boring, especially when repeatedly practicing and memorizing. If learning is only done by studying grammar, sentences and simple practice of common contents, the learning performance will be limited.

The reason for poor performance in language learning is that conventional instruction overemphasizes the integrity of contents, but neglects the assisting factors, such as interest, concentration and imagination during learning, that greatly improve the efficiency of learning. The conventional instruction process lacks versatile activities or high interaction between the instructor and the learner. The learner cannot get into the situation to arouse his or her interest, concentration and imagination, so effective learning cannot be achieved.

In order to solve the above problems of conventional language learning, the invention provides an easy and convenient computer assisted learning system that utilizes computer technology to overcome the deficiencies of one-way instruction and lack of interest and interaction, so as to improve learning efficiency.

### SUMMARY OF THE INVENTION

The object of the invention is therefore to provide a system and method for learning language through a role-playing game. The role-playing game integrates the learning process of making sentences. The game includes role and situation simulations, interaction and versatile activities. Therefore, the learner will feel interested, pay attention to learning and fully utilize his or her imagination so that learning can be efficiently achieved.

A system for learning language through a role-playing game according to the invention includes at least a role-playing central monitoring module, a scene control module, a game content database, an event-activated sentence-learning module and a Q&A sentence database.

A method for learning language through a role-playing game according to the invention includes at least the steps of: generating a role and correspondent scene according to a selection; processing an interactive sentence-learning progress triggered by certain events; and processing the role-playing game according to the results of the sentence-learning progress.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a block diagram showing the functional construction of a system and method for learning language through a role-playing game according to the invention;

FIG. 2-a is a main flowchart of a system and method for learning language through a role-playing game according to the invention;

FIG. 2-b is a flowchart of event-triggering in a system and method for learning language through a role-playing game according to the invention;

FIG. 2-c is a flowchart of sentence-learning in a system and method for learning language through a role-playing game according to the invention;

FIG. 3-a is an embodiment in a system and method for learning language through a role-playing game according to the invention;

FIG. 3-b is an embodiment in a system and method for learning language through a role-playing game according to the invention; and FIG. 3-c is an embodiment in a system and method for learning language through a role-playing game according to the invention.

### DETAILED DESCRIPTION OF THE INVENTION

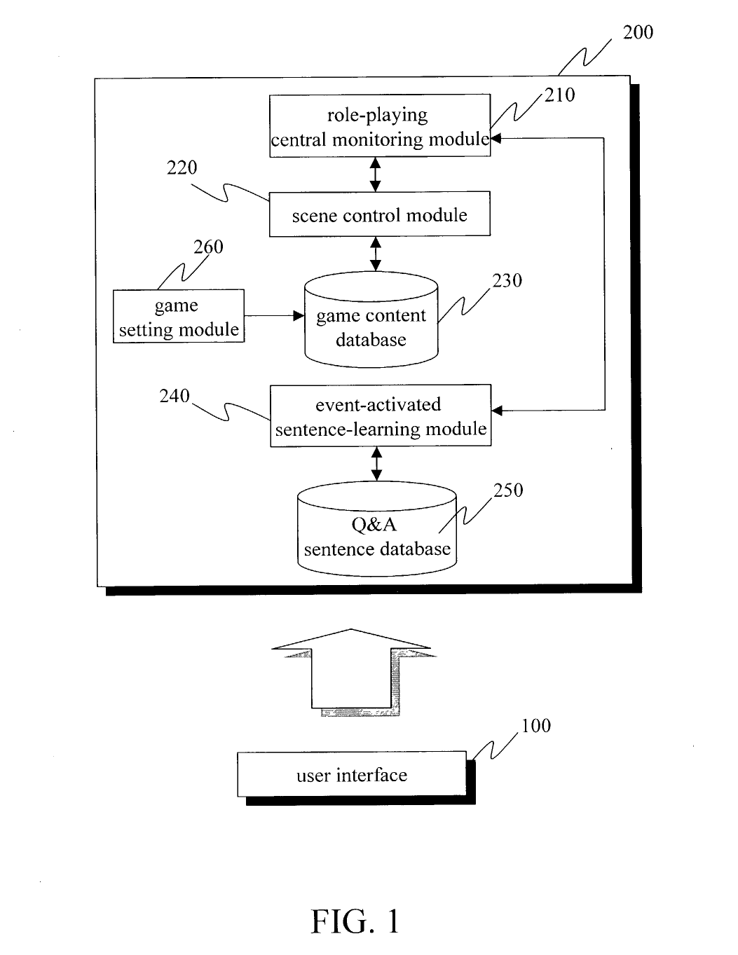

As shown in FIG. 1, a system and method for learning language through a role-playing game according to the invention includes the following functional modules:

a) a role-playing central monitoring module 210, for moving the character according to the user's choices and operations, and providing position information (the X-Y coordinates) of the character to a scene control module 220 and an event-activated sentence-learning module 240 for corresponding operations;

b) a scene control module 220 for generating control codes, which correspond to a user's choice and the position information of the character in the scene, for determining the situations of the game, including scenes, the flow of the game and some predetermined events. The scene module 220 dynamically provides different situations according to the results of the interactive learning process of the user;

c) a game content database 230, for providing a situation of the game according to the control codes transferred by the scene control module 220. Actually, the invention also provides a game setting module 260 for a user to set up the characters, environments and events of the game so as to make the game more interesting and versatile;

d) an event-activated sentence-learning module 240 for generating triggering codes, which correspond to the operation of the character in the game, for determining the correspondent sentences for the user to learn; and

e) a Q&A sentence database 250 for generating a sentence number and providing question and answer information (including sentence number, texts of the question and the answer, and speech of the question and the answer, etc.) according to the triggering code provided by the event-activated sentence-learning module 240.

The system also provides a memory device for storing and retrieving the user's learning progress. The event-activated sentence-learning module includes an adder and a register. The adder receives the user's input and queues data in a first-in first-out manner so that the user's input can be stored and compared.

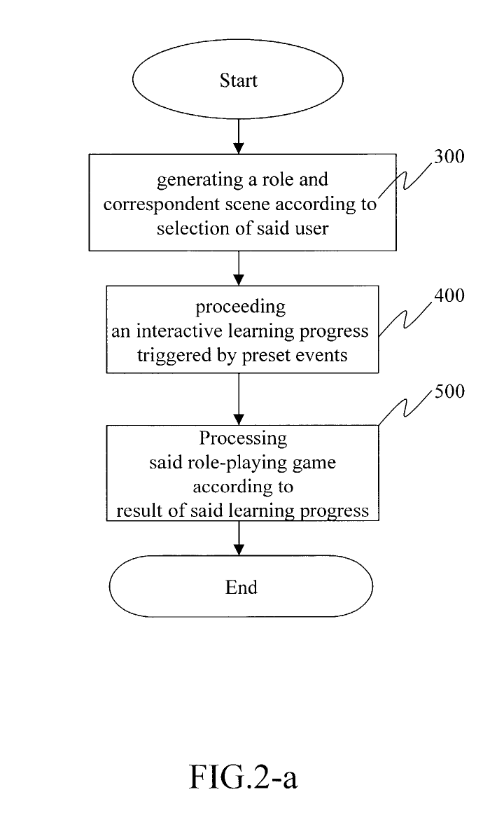

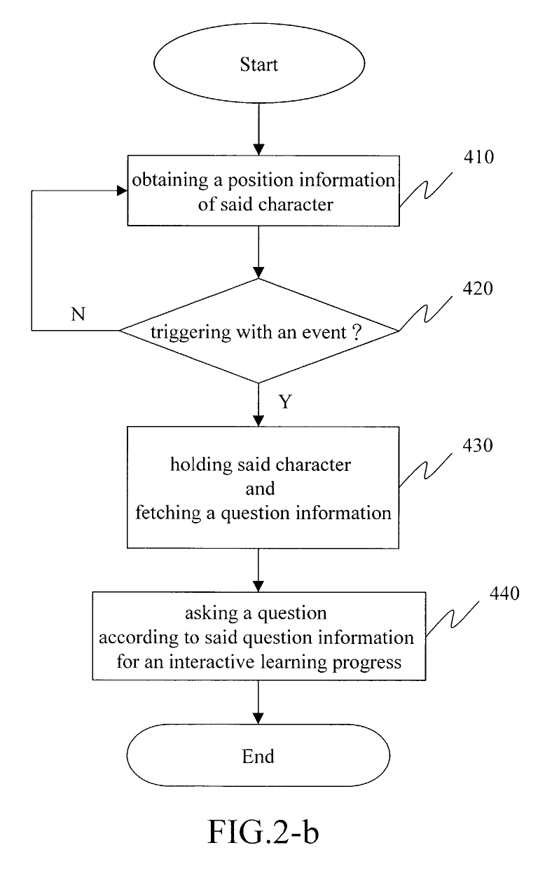

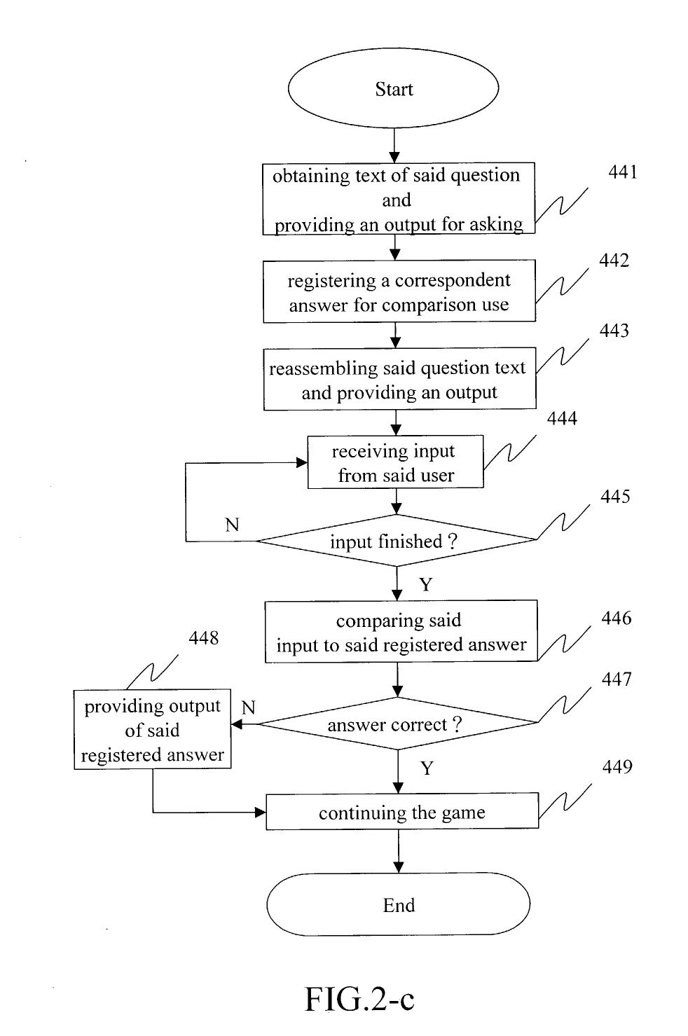

The process of operation according to the invention will further be described with FIGS. 2-a, 2-b and 2-c as follows. FIG. 2-a is the main flowchart of a system and method for learning language through a role-playing game according to the invention. The system first generates a role and corresponding scene according to the selection of the user (step 300). The scene is dynamically generated in accordance with the action of the character in the game and the learning history (for example, the progress of learning) registered in the system. Then, the system processes an interactive sentence-learning progress triggered by preset events (step 400), which will be further described in FIG. 2-b. Each time the user finishes a sentence-learning progress, the system generates a result of the learning progress for determining whether the character in the game passes a level, and further processes the role-playing game according to the result of the sentence-learning progress (step 500).

FIG. 2-b is a detailed flowchart of the event-triggering in step 400. The system first monitors the position of the character in the game by reading the positional information (step 410). Then, the system determines if a preset event is triggered (step 420). In other words, the relative coordinate of the character in the game is compared with preset positional information of events. The movement of the character is processed if the position doesn't match the preset values. Otherwise, a certain event is triggered when the position matches, a correspondent sentence type is then retrieved (step 430), and a question of the sentence type is selected from the Q&A sentence database 250. The sentence is provided for the user to learn through an interactive learning progress (step 440), which will be further described with FIG. 2-c.

FIG. 2-c is a flowchart of the sentence-learning progress. After a sentence type is determined, the system selects a set of question and answer information (including sentence number, texts of the question and the answer, translation of the texts and speech of the question and the answer, etc.). The question information (the text and the speech) is then provided to the user in a preset output manner (e.g., display and speech) (step 441). The answer information (the text and the speech) is stored to a register (step 442) for comparison purposes. The answer texts are randomly reassembled and provided to the user for reference of answering (step 443). The system then waits for the input of the user (step 444). After the input is finished (step 445), the system compares the input with the answer in the register (step 446). If the input is incorrect, the system provides the correct answer to the user for reference and learning (step 448). Otherwise, the input is correct, the user passes the level of the game or the progress of learning, and is allowed to finish the game or proceed to a higher level (step 449).

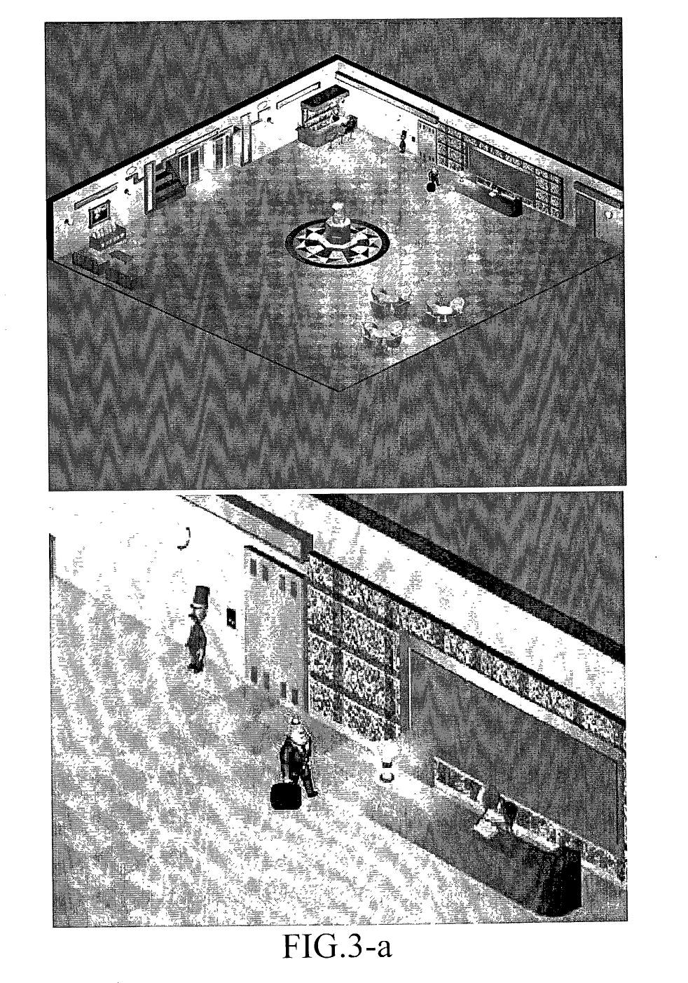

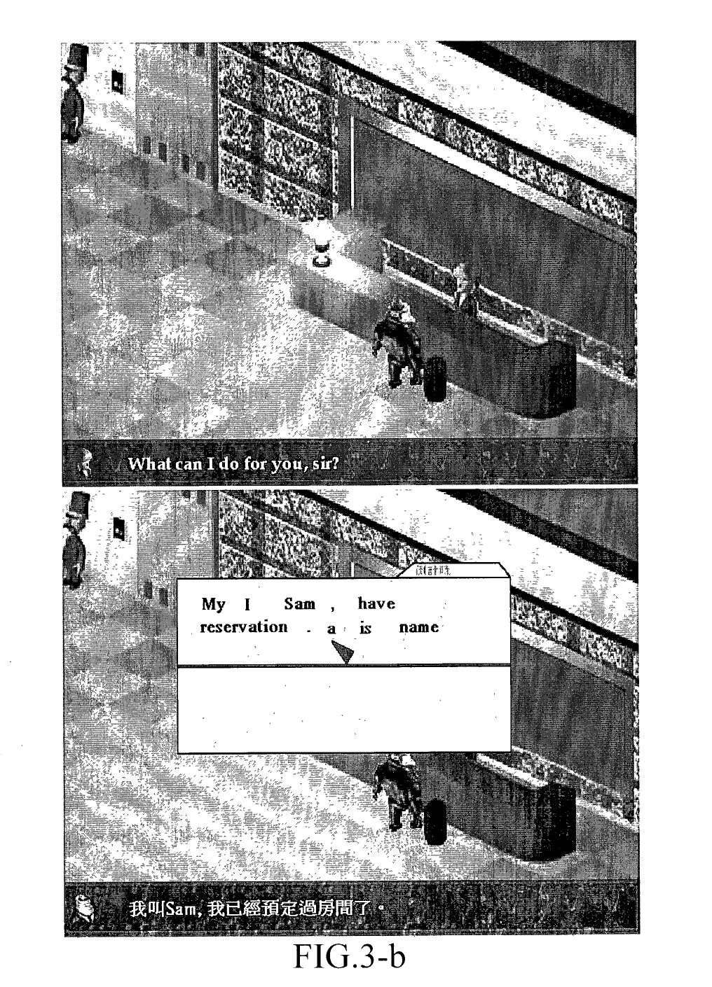

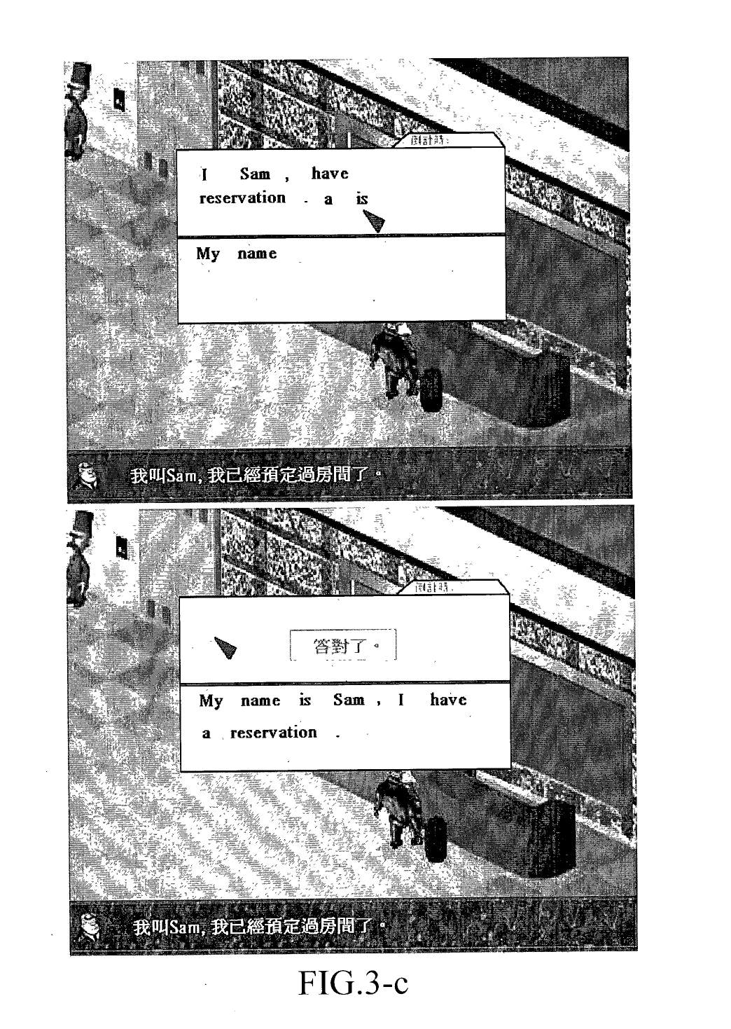

FIGS. 3-a, 3-b and 3-c are sequential display frames of an embodiment of the invention. In the beginning, the user freely moves the character around the scene. Since there are some preset events related to the position, the character can trigger an event in a specific position. For example, when the character moves to the counter in a restaurant, a conversation between the waitress and the character is triggered. The system then looks up the sentence type of the event, randomly selects a question of the sentence type, and provides text display and speech to the user. For example, a question “What can I do for you, sir” is asked. The system randomly reassembles the answer and provides it for the user reference. The user has to assemble the reference words for an answer in due time. The system checks the answer. If it is correct, for example, an answer of “My name is Sam, I have a reservation”, the user can proceed with further learning. Otherwise, the system provides the correct answer or further instructions for the user to refer and learn.

As described above, the invention provides a system and method for learning language through a role-playing game. The role-playing game integrates the learning process of making sentences. The game includes role and situation simulations, interactive learning and versatile scene and events. Therefore, the learner feels interested, pays attention to learning and fully utilizes his or her imagination and memorization so that learning can be efficiently achieved. The invention is applicable to a personal computer, a notebook or a personal digital assistant. The user's input can be made through a keyboard, mouse, touch panel or a speech-operated device

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for a user to learn language through simulation with a character in a role-playing game, comprising:
a role-playing central monitoring module, for moving said character according to the user's choice and operation, and providing position information of said character;
a scene control module, for generating control codes corresponding to said position information and determining scenes of the game;
a game content database, for providing at least a situation of the game according to said control codes;
an event-activated sentence-learning module, for generating triggering codes corresponding to said position information of said character; and
a Q&A sentence database, for generating at least a group of question information; thereby an interactive learning progress is achieved.

2. A system as recited in claim 1, wherein the system further comprises means for loading and saving progress information of said user.

3. A system as recited in claim 1, wherein said position information comprises relative X and Y coordinates.

4. A system as recited in claim 1, wherein said situation of the game comprises at least a scene, a game flow and preset triggering events.

5. A system as recited in claim 1, wherein said game content database further comprises a game setting module for user to set up characters, situations and events.

6. A system as recited in claim 1, wherein said scene control module generates scenes according to saved learning progress of said user.

7. A system as recited in claim 1, wherein said event-activated sentence-learning module processes events according to saved learning progress of said user.

8. A system as recited in claim 1, wherein said event-activated sentence-learning module comprises an adder and a register.

9. A system as recited in claim 8, wherein said adder receives user's input and queues data in a first in first out manner.

10. A system as recited in claim 8, wherein said register stores a data for comparison with data queued in said adder.

11. A system as recited in claim 1, wherein said question information comprises at least a sentence number, texts of said question and answer, and speech of said question and answer.

12. A system as recited in claim 1, wherein said role-playing game is operated through one user interface which is selected from a group of personal computer, notebook and personal digital assistant and input via an input device.

13. A system as recited in claim 12, wherein said input device is selected from a group of keyboard, mouse, touch panel and speech-operated device.

14. A system as recited in claim 1, wherein said interactive learning progress comprises progress of user's operation and progress of user's learning.

15. A method for a user to learn language through simulation with a character in a role-playing game comprising steps of:
generating a role and correspondent scene according to selection of said user;
proceeding an interactive learning progress triggered by preset events; and
processing said role-playing game according to result of said learning progress.

16. A method as recited in claim 15, wherein said step of proceeding an interactive learning progress comprises steps of user's operation and steps of user's learning.

17. A method as recited in claim 15, wherein said step of proceeding an interactive learning progress further comprises steps of:
obtaining a position information of said character;
triggering with an event;
holding said character and fetching a question information; and
asking a question according to said question information for an interactive learning progress.

18. A method as recited in claim 17, wherein said position information comprises relative X and Y coordinates.

19. A method as recited in claim 17, wherein said question information comprises at least a sentence number, texts of said question and answer, and speech of said question and answer.

20. A method as recited in claim 17, wherein said step of asking a question for an interactive learning progress further comprises steps of:
obtaining text of said question and providing an output for asking;
registering a correspondent answer for comparison use;
reassembling said question text and providing an output;
receiving input from said user;
comparing said input to said registered answer; and
continuing the game.

21. A method as recited in claim 20, wherein said step of comparing said input to said registered answer further comprises step of providing output of said registered answer.

22. A method as recited in claim 20, wherein said output for asking comprises speech and text.

23. A method as recited in claim 20, wherein said user's input is operated through one device selected from a group of keyboard, mouse, touch panel and speech-operated device.
